(19) United States
(12) Patent Application Publication
(10) Pub. No.: US 2008/0002742 A1
(43) Pub. Date: Jan. 3, 2008

(54) RECEIVER SYSTEM AND RELATED METHOD FOR PROCESSING ERROR PACKETS UTILIZING PACKET REPLACEMENT

(76) Inventor: Chung-Bin Wu, Kao-Hsiung City (TW)

Correspondence Address: NORTH AMERICA INTELLECTUAL PROPERTY CORPORATION, P.O. BOX 506, MERRIFIELD, VA, 22116, US

(21) Appl. No.: 11/427,335

(22) Filed: Jun. 28, 2006

(51) Int. Cl. H04J 3/00

(52) U.S. Cl. 370/476; 370/392

(57) ABSTRACT

According to an embodiment of the present invention, a method for processing error packets includes identifying an error packet in the incoming data stream, replacing at least a portion of the error packet with a predetermined error indication pattern to indicate the presence of errors, and decoding the data stream; wherein a segment corresponding to the error is specially treated when the predetermined error indication pattern is detected.

### BACKGROUND

The present invention relates to handling error packets in a decoding process, and more particularly, to a receiver system and method of replacing error packets with a predetermined error indication pattern to signal the presence of error packets.

FIG. 1 is a diagram of a related art DTV receiver system 100. As shown in FIG. 1, the DTV receiver system 100 comprises a demodulator 102, a demultiplexer 104, a plurality of buffers 106, 107, a video decoder 108, and an audio decoder 110. The demodulator 102 receives an input signal (i.e. a DTV signal received by a TV tuner) and demodulates the input signal to generate a demodulated input signal. The demultiplexer 104 receives the demodulated input signal and separates the demodulated input signal into video and audio signals that are sent to backend decoders, namely the video decoder 108 and the audio decoder 110. The backend decoders 108 and 110 receive video and audio signals to perform video decoding and audio decoding respectively. The DTV signal is a data stream encoded in packets. When the received input signal, which has error packets, is propagated to the decoders, the decoders regard the incoming signal as a good signal to start decoding until errors are detected. It should be noted that there is usually a delay time between the start point of decoding a packet and the timing of identifying the currently processed packet as an error packet. Before identifying the error(s), the error packet will be decoded as usual, however, decoding such error packet may generate unexpected and unwanted results, such as a mosaic block with uncomfortable colors, a broken picture with high shifted motion, an uncomfortable sound, and so on. Therefore, in U.S. Pat. No. 5,579,317, a method of inserting an extra header to each packet is used to indicate whether the corresponding packet is error-free or not. FIG. 2 is a diagram showing an extra bit inserted in the header for indicating validity of the packet. As shown in FIG. 2, the header consists of sixteen bits in total, where eight bits are used for carrying the number of bytes, an error bit is for indicating the error, and seven bits are for reserved options. This inserted extra header will notify decoders to perform certain actions to avoid decoding error data if the error bit of the header is set. This method for indicating error data is not cost-efficient since an extra header bit is required for each packet in the original data stream, potentially increasing transmission bandwidth requirements. Dedicated hardware is therefore needed to be implemented in decoders to process extra headers added to the original data stream.

### SUMMARY

Therefore one of the objectives of the present invention is to provide a method and receiver system for replacing error packets with a predetermined error indication pattern to signal the presence of error packets.

According to an embodiment of the claimed invention, an error handling method is disclosed. The method comprises identifying an error packet in a data stream, replacing at least a portion of the error packet with a predetermined error indication pattern to indicate the presence of errors in the data stream, and decoding the data stream. A segment of the data stream is specially treated during decoding when the predetermined error indication pattern is detected. In some embodiments, the segment is skipped, replaced, or estimated based on previous data, for example, applying error concealment until valid data is detected. A possible valid data detection method comprises detecting a start code indicating the beginning of a valid slice, picture, or sequence.

According to an embodiment of the claimed invention, a receiver system capable of error handling is disclosed. The receiver system comprises a receiving module and a decoding module. The receiving module receives a data stream, identifies an error packet in the data stream, and replaces at least a portion of the error packet with a predetermined error indication pattern to indicate the presence of errors in the data stream. The decoding module is coupled to the receiving module for decoding the data stream, when detecting the predetermined error indication pattern, the decoding module treats a segment of the data stream in a special way. In some embodiments, the segment is skipped, replaced, or estimated based on previous data, for example, applying error concealment until valid data is detected.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a related art DTV receiver system.

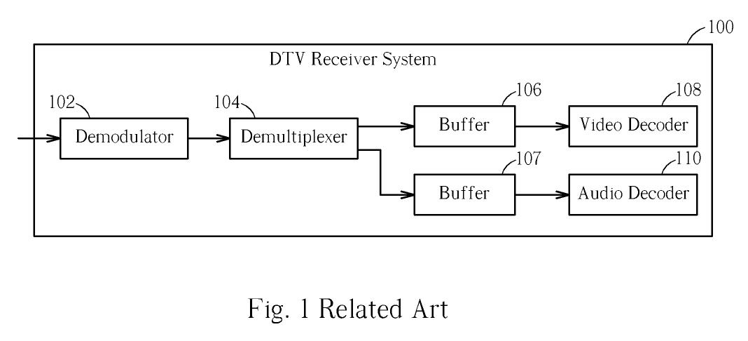

FIG. 2 is a diagram illustrating an extra header inserted in each packet for error indication.

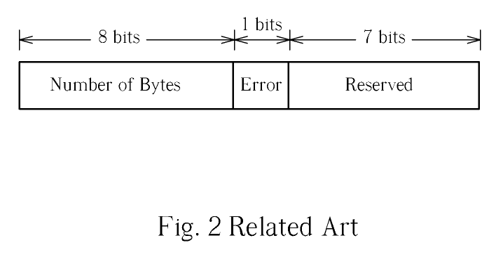

FIG. 3 is a diagram of a receiver system according to an embodiment of the present invention.

FIG. 4 is a flow chart illustrating operation of a packet replacement scheme for video decoding according to an embodiment of the present invention.

FIG. 5 is a flow chart illustrating operation of an adaptive packet replacement scheme for video decoding according to an embodiment of the present invention.

FIG. 6 is a flow chart illustrating operation of a packet replacement scheme for audio decoding according to an embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

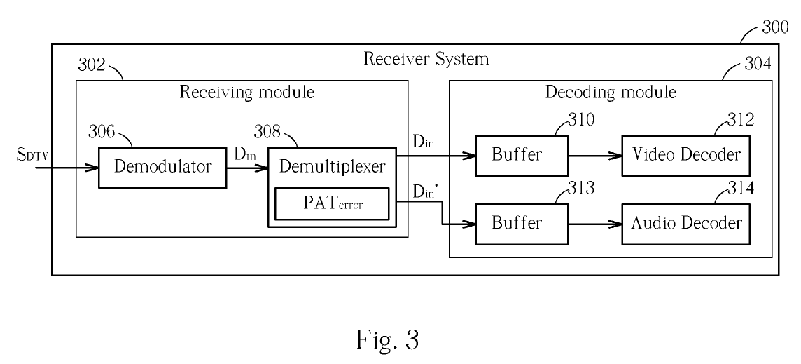

FIG. 3 is a diagram of a receiver system 300 according to an embodiment of the present invention. In this embodiment, the receiver system 300 acts as a DTV receiver system for processing incoming DTV signals, however, this is not meant to be a limitation of the present invention. As shown in FIG. 3, the receiver system 300 comprises a receiving module 302 and a decoding module 304, wherein the receiving module 302 comprises a demodulator 306 and a demultiplexer 308, and the decoding module 304 comprises buffers 310, 313, a video decoder 312 and an audio decoder 314. An embodiment of the receiver system 300 complies with a Motion Picture Expert Group (MPEG) specification, and the decoding module 304 decodes a data stream Dᵢₙ outputted from the receiving module 302. The demodulator 306 receives an input signal (i.e. a DTV signal) S_{DTV} and demodulates the input signal S_{DTV} to generate a multimedia data stream Dₘ carrying packets. The demultiplexer 308 separates the multimedia data stream Dₘ into a video stream (i.e. Dᵢₙ shown in FIG. 3) and an audio stream (i.e. Dᵢₙ′ shown in FIG. 3), and transmits the data streams Dᵢₙ and Dᵢₙ′ to the decoding module 304 for audio decoding and video decoding. The video stream Dᵢₙ transmitted to the decoding module 304 is sometimes referred to as an elementary stream (ES). The buffer 310 in the decoding module 304 is used for buffering the video stream Dᵢₙ, and the video decoder 312 decodes video information carried by the video stream Dᵢₙ outputted from the buffer 310. Similarly, the buffer 313 is used for buffering the audio stream Dᵢₙ′, and the audio decoder 314 decodes audio information carried by the audio stream Dᵢₙ′.

When the input signal S_{DTV} has errors associating with the video information and an error packet is detected, the demultiplexer 308 replaces at least a portion of the error packet with a predetermined error indication pattern PATₑᵣᵣₒᵣ to indicate the presence of errors in the data stream, and the modified video stream Dᵢₙ or audio stream Dᵢₙ′ is transmitted to the video decoder 312 or audio decoder 314. The predetermined error indication pattern PATₑᵣᵣₒᵣ is a specific data pattern that can be easily recognized by the decoder. In some embodiments, the decoder can detect PATₑᵣᵣₒᵣ in the data stream without any additional circuitry. For example, PATₑᵣᵣₒᵣ may be a “forbidden” data pattern in the MPEG specification. When detecting the predetermined error indication pattern PATₑᵣᵣₒᵣ in the data stream, the decoder immediately drops a data segment referenced by the predetermined error indication pattern PATₑᵣᵣₒᵣ and decodes the next valid data (for example, a valid slice, picture, or sequence). Though the erroneous segment is dropped, the decoder can adopt any well-known schemes such as error concealment to estimate an information segment corresponding to the missing information contained in the dropped erroneous segment. Since this operation is known to those skilled in this art, further description is omitted for brevity. The receiver system 300 may implement an adaptive error handling mechanism, for example, simply drop the error packet if the defect affects an entire picture (e.g. packet containing the header information), or replace the error packet with a predetermined error indication pattern if the defect only affects a microblock (MB). In some embodiments, the decoding module 304 may simply replace the erroneous segment by a copy of previous data, for example, a previous picture. This will later be described in details.

In this embodiment, each time the video decoder 312 detects a predetermined error indication pattern PATₑᵣᵣₒᵣ, it drops an erroneous segment directly without performing any further video decoding, and continues in decoding when it detects a start code indicating the beginning of a valid slice, picture, or sequence. Therefore, compared to the above related art DTV receiver system 100, erroneous video information contained in the error packet replaced by the replacement pattern is never processed by the video decoder 312. As a result, the final video display quality will be not degraded since the estimated video information segment is much more reliable than the erroneous video information. In addition, since the video decoder 312 is able to acknowledge error packets without extra hardware, the cost and system complexity is reduced compared to the above-mentioned detection scheme disclosed in U.S. Pat. No. 5,579,317.

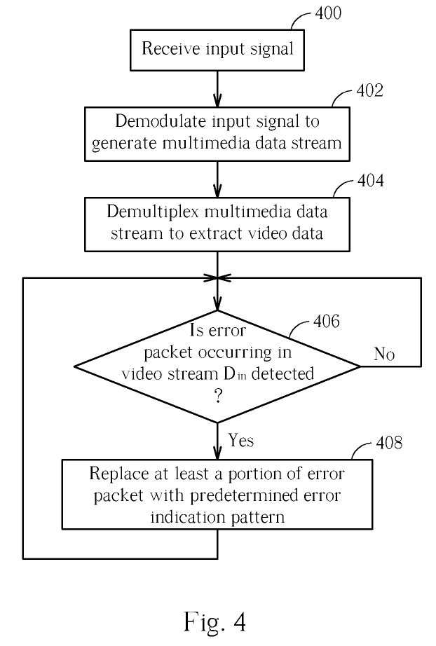

FIG. 4 is a flow chart illustrating an operation of the packet replacement scheme for video decoding according to an embodiment of the present invention. The packet replacement scheme, applied to the receiver system 300 shown in FIG. 3, includes the following steps:

Step 400: Receive an input signal S_{DTV};

Step 402: Demodulate the input signal S_{DTV} to generate a multimedia data stream Dₘ;

Step 404: Demultiplex the multimedia data stream Dₘ to extract video data;

Step 406: Detect if an error packet occurs in the video stream Dᵢₙ. If yes, go to step 408; otherwise, continue executing step 406 to monitor the existence of any error packet; and

Step 408: Replace at least a portion of the error packet with a predetermined error indication pattern PATₑᵣᵣₒᵣ, and then go back to step 406.

Please note that the choice of the predetermined error indication pattern PATₑᵣᵣₒᵣ can be made by the designers, however, in a preferred embodiment, bit pattern selected for error indication should be easily acknowledge by the decoder without additional circuits.

In the above embodiment, the demultiplexer 308 will replace each error packet with the predetermined error indication pattern PATₑᵣᵣₒᵣ to indicate the presence of errors. However, if a packet defined to carry header information associated with decoding of a full picture contains errors, decoding erroneous header information corresponding to this full picture fails to produce a desired result even though this error packet is replaced. This is because the correct header information is critical for decoding the full picture. If the header information is corrupt, decoding data following the erroneous header information still results in an erroneous picture. Therefore, in another embodiment of the present invention, an adaptive packet replacement scheme is provided. The operation is detailed as below.

When the input signal S_{DTV} has errors and an error packet is detected, the demultiplexer 308 drops the error packet directly if the error packet includes header information of a full picture, or replaces the error packet with the predetermined error indication pattern PATₑᵣᵣₒᵣ. In this embodiment, as the error packet including header information of a full picture is dropped, the demultiplexer 308 will drop following packets associated with this full picture. In addition, the operation of replacing the error packet with the predetermined error indication pattern PATₑᵣᵣₒᵣ is identical to that mentioned above, and further description is thus omitted for brevity.

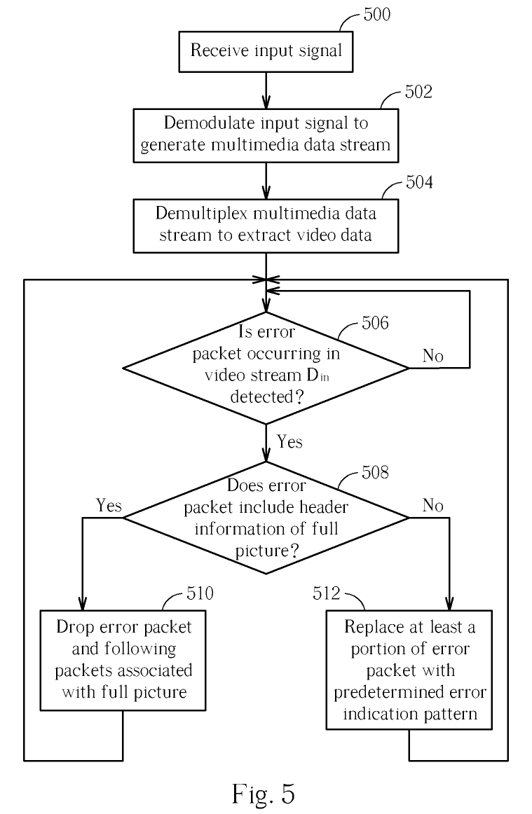

FIG. 5 is a flow chart illustrating an operation of the adaptive packet replacement scheme for video decoding according to an embodiment of the present invention. The adaptive packet replacement scheme applied to the receiver system 300 shown in FIG. 3 includes the following steps:

Step 500: Receive an input signal S_{DTV};

Step 502: Demodulate the input signal S_{DTV} to generate a multimedia data stream Dₘ;

Step 504: Demultiplex the multimedia data stream Dₘ to extract video data;

Step 506: Detect if an error packet occurs in the video stream Dᵢₙ. If yes, go to step 508; otherwise, continue executing step 506 to monitor the existence of any error packet;

Step 508: Determine if the error packet includes header information of a full picture. If yes, go to step 510; otherwise, go to step 512;

Step 510: Drop the error packet and following packets associated with the full picture, then go back to step 506; and

Step 512: Replace at least a portion of the error packet with a predetermined error indication pattern PATₑᵣᵣₒᵣ, then go back to step 506.

In the above disclosure, the packet replacement scheme is applied to video decoding. However, it can be applied to audio decoding as well. As shown in FIG. 3, the audio decoder 314 is used for decoding the audio stream (i.e. Dᵢₙ′). In an embodiment that applies a packet replacement scheme to audio decoding, when the input signal S_{DTV} has errors affecting transmitted audio information and an error packet is then detected, the demultiplexer 308 replaces the error packet with a predetermined error indication pattern PATₑᵣᵣₒᵣ to indicate the presence of errors in the error packet, and the modified audio stream Dᵢₙ′ is then transmitted to the audio decoder 314. In this embodiment, the predetermined error indication pattern PATₑᵣᵣₒᵣ is a specific packet that can be acknowledged by the audio decoder 314 with or without extra hardware implemented therein. When detecting the predetermined error indication pattern PATₑᵣᵣₒᵣ in the audio stream Dᵢₙ′, the audio decoder 312 immediately drops a segment corresponding to the detected error indication pattern PATₑᵣᵣₒᵣ and decodes the next valid audio data. Please note that the predetermined error indication pattern utilized in the packet replacement scheme for audio decoding is not limited to be identical to that utilized in the packet replacement scheme for video decoding.

In one case where decoding of the audio stream Dᵢₙ′ (e.g. an AC3 audio stream) requires a cyclic redundancy code (CRC) check, replacing the error packet with the predetermined error indication pattern PATₑᵣᵣₒᵣ greatly boosts the error detection efficiency of the audio decoder 314 for dropping data that should not be decoded in an early stage. If the packet having errors is decoded, the audio playback will generate uncomfortable sound such as noise. In another case where decoding of the audio stream Dᵢₙ′ (e.g. an MP3 audio stream) does not require a CRC check, replacing the error packet with the predetermined error indication pattern PATₑᵣᵣₒᵣ still improves the error detection efficiency of the audio decoder 314 for dropping data that should not be decoded.

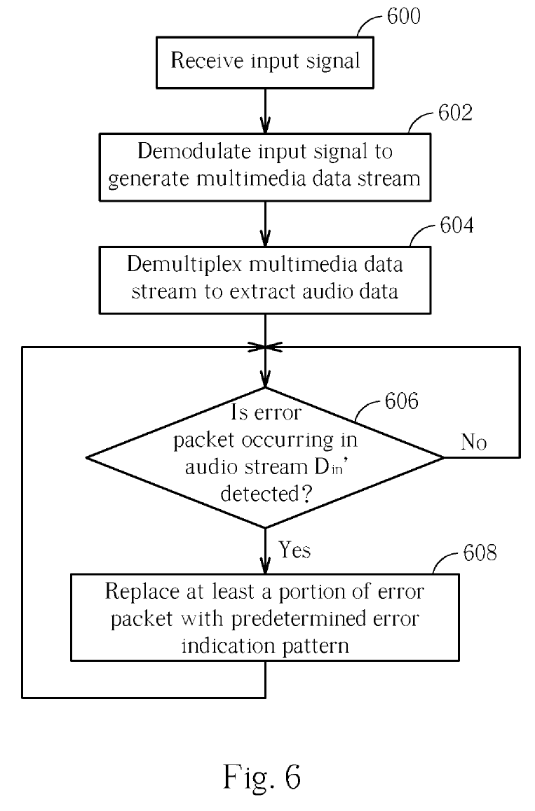

FIG. 6 is a flow chart illustrating an operation of the packet replacement scheme for audio decoding according to an embodiment of the present invention. The packet replacement scheme applied to the receiver system 300 shown in FIG. 3 includes the following steps:

Step 600: Receive an input signal S_{DTV};

Step 602: Demodulate the input signal S_{DTV} to generate a multimedia data stream Dₘ;

Step 604: Demultiplex the multimedia data stream Dₘ to extract audio data;

Step 606: Detect if an error packet occurs in an audio stream Dᵢₙ′. If yes, go to step 608; otherwise, continue executing step 606 to monitor the existence of any error packet; and

Step 608: Replace at least portion of the error packet with a predetermined error indication pattern PATₑᵣᵣₒᵣ, then go back to step 606.

It should be noted that, in the above embodiments, the predetermined error indication pattern PATₑᵣᵣₒᵣ is not limited to have a bit length matching that of a packet. In other embodiments of the present invention, the demultiplexer 308 can replace a portion of the error packet with the predetermined error indication pattern PATₑᵣᵣₒᵣ to indicate the presence of errors in the error packet, and the choice of the predetermined error indication pattern PATₑᵣᵣₒᵣ is preferred to be chosen according to what the video decoder 31 2/audio decoder 314 can acknowledge. Similarly, when detecting the predetermined error indication pattern PATₑᵣᵣₒᵣ, the video decoder 312/audio decoder 314 skips the packet containing the predetermined error indication pattern PATₑᵣᵣₒᵣ, and then decodes the next received packet. Under this condition, replacing a portion of an error packet from the beginning of the error packet is preferred because the video decoder 312/audio decoder 314 can quickly identify the error packet during the decoding process to efficiently prevent the final video display quality/audio playback quality from being degraded. Please note the choice of replacing a portion of the error packet mentioned above is not meant to be a limitation of the present invention.

The packet replacement scheme/adaptive packet replacement scheme for video decoding and the packet replacement scheme for audio decoding can be activated simultaneously to optimize both the video display quality and audio playback quality. However, the present invention is not limited to this operation. For example, if only the packet replacement scheme/adaptive packet replacement scheme for video decoding is applied, the video display quality can be improved; and if only the packet replacement scheme for audio decoding is applied, the audio playback quality can be improved. In short, in either case, the user can enjoy better audio/video entertainments when viewing DTV programs.

Some possible ways of detecting errors in a video or audio stream are further described in the following. A transport error indicator field is set by a transmitter (i.e. a signal source) to indicate if there are errors in a packet. The demodulator 306 transmits the transport error indicator field to inform the demultiplexer 308 and then the demultiplexer 308 identifies an error packet by referencing each received transport error indicator field from the demodulator 306. If errors are detected in the input signal S_{DTV}, in some embodiments, the demodulator 306 will inform the demultiplexer 308 of error packets. In some other embodiments, the demultiplexer 308 itself is well designed to detect errors in the multimedia data stream Dₘ. Therefore, any means of detecting errors in a video or audio stream are suitable for use in the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for processing error packets, comprising:
identifying an error packet in a data stream;
replacing at least a portion of the error packet with a predetermined error indication pattern to indicate the presence of errors in the data stream; and
decoding the data stream;
wherein a segment of the data stream is specially treated during decoding when the predetermined error indication pattern is detected.

2. The method of claim 1, wherein the portion starts from the beginning of the error packet.

3. The method of claim 1, wherein the whole error packet is replaced with the predetermined error indication pattern.

4. The method of claim 1, wherein the step of replacing the portion of the error packet with the predetermined error indication pattern further comprises:
when the error packet includes header information of a complete picture, dropping the error packet directly; otherwise, replacing the portion of the error packet with the predetermined error indication pattern.

5. The method of claim 1, further comprising:
demultiplexing a multimedia data stream to generate a video stream and an audio stream, wherein the data stream is either the video stream or the audio stream.

6. The method of claim 5, further comprising:
demodulating an input signal to generate the multimedia data stream.

7. The method of claim 6, wherein the input signal complies with a DTV specification.

8. The method of claim 1, wherein the segment is skipped, replaced, or estimated base on previous data when the predetermined error indication pattern is detected.

9. The method of claim 1, wherein the step of decoding further comprises specially treating the data stream until detecting of valid data.

10. The method of claim 9, wherein the valid data is determined by detection of a start code indicating the beginning of a valid slice, picture, or sequence.

11. A receiver system for processing error packets, comprising:
a receiving module, receiving a data stream, identifying an error packet in the data stream, and replacing at least a portion of the error packet with a predetermined error indication pattern to indicate the presence of errors; and
a decoding module, coupled to the receiving module, decoding the data stream, when detecting the predetermined error indication pattern, the decoding module treats a segment of the data stream corresponding to the predetermined error indication pattern in a special way.

12. The receiver system of claim 11, wherein the portion starts from the beginning of the error packet.

13. The receiver system of claim 11, wherein the whole error packet is replaced with the predetermined error indication pattern.

14. The receiver system of claim 11, wherein the receiving module drops the error packet directly when the error packet includes header information of a complete picture; otherwise, the receiving module replaces the portion of the error packet with the predetermined error indication pattern.

15. The receiver system of claim 11, wherein the receiving module comprises:
a demutiplexer, coupled to the decoding module, for demutiplexing a multimedia data stream to generate a video stream and an audio stream, and for replacing at least the portion of the error packet with the predetermined error indication pattern; wherein the data stream is either the video stream or the audio stream.

16. The receiver system of claim 15, wherein the demutiplexer further identifies the error packet in the multimedia data stream.

17. The receiver system of claim 15, wherein the receiving module further comprises:
a demodulator, coupled to the demultiplexer, for demodulating an input signal to generate the multimedia data stream.

18. The receiver system of claim 17, wherein the demodulator further identifies the error packet in the input signal and then informs the demultiplexer of the error packet.

19. The receiver system of claim 17, wherein the demodulator extracts a transport error indicator field in each packet of the multimedia data stream to the demultiplexer, and the demultiplexer further identifies the error packet in the multimedia data stream by referencing each transport error indicator field received from the demodulator.

20. The receiver system of claim 17, wherein the input signal complies with a DTV specification.

21. The receiver system of claim 11, wherein the decoder skips, replaces, or estimates the segment based on previous data when the predetermined error indication pattern is detected.

22. The receiver system of claim 11, wherein the decoder treats the data stream in a special way until detecting of valid data.

23. The receiver system of claim 22, wherein the valid data is determined by detection of a start code indicating the beginning of a valid slice, picture, or sequence.
